(19) United States
(12) Patent Application Publication
(10) Pub. No.: US 2011/0111188 A1
(43) Pub. Date: May 12, 2011

(54) PROCESS FOR FORMING AN IMAGE ON A TRANSPARENT ACRYLIC ARTICLE

(76) Inventors: Ming Xu, Malvern, PA (US); Zhenrong Guo, Mt. Pleasant, SC (US); Sukun Zhang, Mt Pleasant, SC (US); Paul Hirst, Netherland Ecclesfield (GB)

(21) Appl. No.: 12/944,410

(22) Filed: Nov. 11, 2010

Related U.S. Application Data
(60) Provisional application No. 61/260,442, filed on Nov. 12, 2009.

(51) Int. Cl. B32B 3/10; B44C 1/00; B41M 5/26

(52) U.S. Cl. 428/203; 428/201; 156/234

(57) ABSTRACT

A method of imaging thermoplastics, such as acrylic glass, is presented. An image is formed on a transfer sheet or medium, and is heat transferred to the acrylic glass substrate on which the image is to permanently appear. An opaque pass-through coating is applied to one surface of the clear or transparent acrylic glass article. Heat activatable dye forms the image, and the heat activatable dye, when heat activated in close relationship to the opaque pass-through coating, passes through the opaque pass-through coating to the thermoplastic substrate. The image reflects light through the thermoplastic material and is visible through the material and from the side opposite the opaque coating. The opaque pass-through coating layer permanently bonds to the acrylic glass surface.

Applicant claims the benefit of U.S. Provisional Application Ser. No. 61/260,442 filed Nov. 12, 2009.

Applicant claims priority to pending U.S. patent application Ser. No. 12/613,084 filed Nov. 5, 2009, which claims the benefit of U.S. Provisional Application Ser. No. 61/117,752 filed Nov. 25, 2008, and which claims the benefit of U.S. Provisional Application Ser. No. 61/120,175 filed Dec. 5, 2008, and which claims the benefit of U.S. Provisional Application Ser. No. 61/161,913 filed Mar. 20, 2009.

### FIELD OF THE INVENTION

This invention relates to transfer printing generally, and is more specifically directed to a process for imaging a transparent article.

### BACKGROUND OF THE INVENTION

Transfer printing processes involve physically transferring an image from one substrate to another. Transfer printing processes, such as heat transfer printing may avoid the use of specially made printing equipment. Images may be produced on articles that are difficult to image using direct printing processes, due to the constraints of mechanical, physical and/or chemical structures or properties.

Sublimation transfer processes are used in digital printing applications. These applications are limited to substrates that comprise a synthetic component, such as polyester materials. Coatings comprising synthetic materials, such as polyester resins, may be applied to the surface of articles to provide affinity for sublimation colorants prior to the transfer printing process. Furthermore, due to the characteristics of the sublimation colorants, full color sublimation transfer technology has been mainly used for white or pastel background substrates in order to achieve the best reflective imaging intensity and vividness.

Thermoplastics, such as acrylic polymer or resinous material, chemically known as poly(methyl methacrylate) or poly(methyl 2-methylpropenoate), also known as acrylic glass, with trademarks such as Plexiglas, Polycast, Potix, Lucite, etc, have been decorated for awards and other visual displays because of its low cost, high clarity/transparency and its mechanical, electric and chemical stability.

These thermoplastics are sometimes used in replacement of regular glass materials. However, because of the relatively low softening temperature and/or the glass transition temperature of these materials, images are applied or laminated by imaging methods that do not involve the application of relatively high heat. Screen printing, painting, and mechanical adhesion are examples of imaging which do not require the application of high heat.

This is especially true for extruded acrylic glass. In general, the melting temperature of the extruded acrylic glass is lower than 90° C. Therefore, while these materials are relatively easily molded into various shapes, the low molecular weight and the use of plasticizer in the polymer matrix causes the materials to be sensitive to high temperatures. Applications or images or other decoration at high temperature results in thermal deformation of the thermoplastic, or complete melting of the thermoplastic material.

Sublimation transfer technologies are used in imaging applications. During heat transfer of the printed image, sublimation dyes are activated or sublimated by heat. The image transfers to a final substrate from a transfer media. Heat transfer of sublimation dyes requires that the transfer temperature is sufficiently high to allow the sublimation dyes to gasify, or sublimate. In most cases, the sublimation temperature of these dyes is above 150° C., with heat applied for transfer for 20 seconds or more. The application of heat for this period of time and elevated temperature to conventional extruded acrylic glass results in severe thermal damage of the acrylic glass material. Reducing the time or temperature results in insufficient transfer of colorants, which yields a relatively faint, and unsatisfactory, imaging intensity.

Attempts have been made to coat acrylic glasses with polymeric coating materials, including white pigmented polyester/polyurethane coating, to enhance the receptive of the sublimation dyes, and to enhance the contract of the color images. These coatings, while increasing the affinity to the sublimation dyes, do not reduce the thermal vulnerability of the acrylic glass. Furthermore, the white pigment coatings, with high affinity to sublimation colorants, retain sublimation dyes inside the coating layer, and thereby limit the density and intensity of the image created by the sublimation colorants.

Non-sublimation heat transfer methods from transfer paper have also been used for acrylic glass transfer. Digitally printed transfer paper such as Color Laser Copier (CLC) toner transfer paper has been used. The problems associated with these methods include difficulty in locating or registering the image, difficulty in peeling the transfer paper, lack of image intensity and/or contrast, poor weather fastness, and/or lack of aesthetic attractiveness.

### SUMMARY OF THE INVENTION

The present invention is a method of imaging acrylic glass articles and similar plastic articles, and the resulting imaged articles. An opaque pass-through coating is applied to a surface of the clear or transparent thermoplastic substrate. An image is formed comprising heat activatable colorant, such as sublimation dye. The colorant is heat activated, and transferred to the acrylic glass article on which the image is to permanently appear. The colorant forming the image passes through the opaque pass through coating during heat transfer of the colorants. The image is visible through the acrylic material from the side of the acrylic material that is opposite the opaque coating. The opaque pass-through coating layer and the image are permanently bonded to the acrylic glass surface.

### SUMMARY OF THE DRAWINGS

FIG. 1 demonstrates a preferred acrylic glass substrate 4 with an opaque pass-through coating polymer layer 8 suitable for sublimation printing and transfer processes according to the invention, and an optional sublimation dye high affinity layer 6.

FIG. 2 demonstrates a viewing scenario for the finished acrylic glass article, with a sublimation image 2 positioned between the opaque pass-through coating layer 8 and the acrylic glass article. The image can be viewed form an opposite surface through the acrylic glass article 4.

FIG. 3 demonstrates the heat transfer process, with heat being applied to the back of the sublimation transfer medium on top of the acrylic glass substrate, creating a temperature gradient, and preventing the thermal deformation of the acrylic glass substrate.

FIG. 4 demonstrates a computer hardware system for printing a transfer sheet or medium.

### DESCRIPTIONS OF PREFERRED EMBODIMENTS

The preferred substrate is a thermoplastic material that allows light to pass through the substrate from one surface to an opposite surface that is imaged according to the invention, so that the image can be viewed through the thermoplastic material. In one embodiment of the present invention, a cast acrylic glass material, poly(methyl methacrylate) or PMMA, is formed by cast polymerization process. The PMMA may have the following chemical formula:

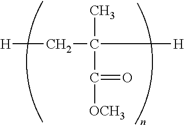

This PMMA is an example of a substrate that is useful as for transfer imaging, such as sublimation imaging, of the thermoplastic substrate according to the invention.

According to an embodiment of the present invention, a piece of transparent, cast acrylic glass has at least two opposing surfaces. One surface is a viewing surface 3. Another imaged surface has a printed image may, which be viewed from viewing surface 3 though the body of the clear and transparent article. The imaged surface 6 comprises an image 2, which may be a full color image by an imaging process, such as a sublimation transfer imaging process.

In one embodiment, cast acrylic glass is used as a substrate 4. Cast acrylic glass possesses high clarity/transparency, and is suitable for signage, glazing and fabricating applications. It generally possesses higher thermal and mechanical stability than extruded acrylic glass materials. The existence of its ester functionality provides an intrinsic affinity to disperse and/or sublimation dyes. Compared to extruded acrylic glasses, cast acrylic glass has a higher mechanical impact strength, as well as superior thermal stability, resistance to thermal deforming, and higher heat capacity. Vicat softening temperature can be as high as 218° C., which is much higher than extruded acrylic glass materials.

While the thermoplastic material, such as acrylic glass, may be transparent, the substrate formed of this material may be translucent or it may be tinted, while still allowing light to pass through from one surface to the opposite surface on which the image appears.

The superior thermal and mechanical properties of cast acrylic glass material are partially due to its higher molecular weight, and the absence of low melting temperature plasticizer. For the present invention, the cast acrylic glass material is preferred to have a molecular weight no less than 150,000, and more preferably, between 500,000 to 2,500,000, with no significant plasticizer, such as phthalates, present in the polymerization composition. Both cell (batch) cast acrylic or continuous (dynamic) cast acrylic may be used.

In an embodiment of the present invention, the acrylic glass article 4 is coated with an opaque pass-through polymer layer 8 on at least one portion of one side of the clear/transparent article. The opaque layer may be a white or off white opaque colored pass-through polymer layer. The material is applied prior to imaging of the article.

The opaque pass-through polymer layer comprises at least one opacifying agent, such as white pigment in the polymer matrix, which provides a high contrast background for the transferred image, which may be a full color image. Preferred opacifying agents are white pigments, such as titanium dioxide, calcium carbonate, aluminum oxide, or zinc oxide, or combinations thereof. Organic white colorants may also be used. Preferably, the opacifying agent or agents comprise 2-30% by weight of the opaque pass-through polymeric layer composition. Too much pigment may result in brittleness of the coating, or high retention and inadequate pass through of the colorant.

The ink used in the application may be a liquid ink. The sublimation transfer process and ink used in the application may be those further described in Hale, et al, U.S. Pat. No. 5,488,907. The term ‘pass-through’ as used herein means that the sublimation colorant printed on the transfer medium will sublimate or diffuse through the polymeric layer during the heat transfer process. However, this layer does not allow cold diffusion pass through of the sublimation image after the transfer process is completed, so that the layer does not materially migrate away from the surface of the thermoplastic material, which would depreciate the image.

The opaque pass-through coating further is preferred to comprise at least one clear polymeric or resinous material(s) with little to no affinity to the heat activated dye, such as sublimation dye. The polymeric or resinous material does not materially interfere with pass through of the sublimation image from the outside of the layer to the acrylic glass during the transfer printing process. The image bonds permanently to the thermoplastic substrate, and between the thermoplastic substrate and the opaque coating layer. Natural or synthetic thermoset or thermoplastic polymeric materials capable of forming a passing-through layer or membrane may be used as ingredient of the coating. Preferably, thermosetting polymeric material(s) react and crosslink to firmly bond, and provide a non-tacky pass-through layer that eliminates peeling issues during the heat transfer process.

Preferred materials for the opaque pass-through polymeric layer are materials that bind to the acrylic substrate with sufficient mechanical strength, and weather and light resistance. Examples are, but are not limited to, used alone or in combination, cellulose and chemically modified cellulose, low density polyethylene, chlorinated polyethylene, polyvinyl chloride, polysulfone, polystyrene or crosslinked polystyrene, melamine/formaldehyde resin, urea/formaldehyde resin, phenol/formaldehyde resin, fluorinated polymers, siloxane and/or modified siloxane polymer materials, copolymers such as polytetrafluoroethylene, and polyvinylidene fluoride. Low molecular weight emulsion polymers, such as polyvinyl alcohol, polyvinyl acetate, polyethylene glycol, or silicon based elastomers may be used. The polymer materials may have aliphatic structures without polyester functionality, which have no or low affinity for sublimation colorants than aromatic polymer materials, allowing low colorant retention, high pass-through efficiency, and high image color density upon transfer to the acrylic glass substrate. Radiation curable monomers, and oligomers/prepolymers of various kinds may also be used, especially if radiation curing, such as UV curing or electron beam curing, are used to form the polymeric layer.

The polymer materials used in the opaque pass-through layer may be cross-linkable. Coating material(s) may first be applied to one surface of the acrylic glass, followed by a material with crosslinking or polymerization properties, and having enhanced bonding and mechanical, physical/chemical and fastness characteristics. Examples of crosslinking materials include epoxies, isocyanate/polyisocyante, polyaspartics, melamine formaldehyde, urea formaldehyde, acrylic/self-crosslinkable acrylic, phenolic, aziridine, acetylacetonate chelate crosslinking or polymerization etc. and the combination of different materials.

Preferably, the crosslinking reaction is carried out at a temperature near or slightly above the softening temperature or glass transition temperature of the acrylic glass material. Solvents or co-solvents that will solubilize acrylic glass materials may be used for the opaque pass-through polymer coating. The thermal stability of the coating is preferred to be no less than that of the acrylic glass substrate.

One or more catalysts may also be used to enhance the crosslink/polymerization reaction efficiency, or to shorten the reaction time and/or lower the reaction temperature. Depending upon the particular crosslinking system, various catalysts suitable for the reaction system may be used. For example, polystannoxane catalysts may be used for blocked isocyanate/polyisocyanate resin. Activated oxo-centered tri-nuclear Cr(III) complexes may be used for epoxy based resin systems, and strong organic acid catalysts such as benzenesulfonic acid (BSA), methanesulfonic acid (MSA), 1,5-naphthalenedisulfonic acid (NDSA), 1-naphthalenesulfonic acid (NSA), para-toluene sulfonic acid (PTSA) or sulfuric acid (SA) may be used as phenolic resin, or 1,3,5-triazine-2,4,6-traiamine-formaldehyde and polyether polyol based resin crosslinking reactions.

The releasing property and non-tackiness of the opaque pass-through polymeric layer may be improved the addition of one or more releasing agents to the coating composition. The high releasing property allows easy of removal of the transfer medium upon completion of the process, inhibiting stains from the transfer medium, and reducing the likelihood of tearing of the transfer medium. Furthermore, the releasing agent may substantially decrease the surface energy of the coated polymeric layer, decreasing undesirable staining or reduction of whiteness, and reducing contamination from close contact or electrostatic attraction of foreign materials.

Suitable releasing agents that may be used with the opaque pass-through polymeric layer include wax and waxy materials such as polyethylene wax, paraffin wax, microcrystalline wax, carnauba wax, high melting point mineral oil, fatty acid, etc. protein releasing agent, fluorocarbon, silicone and modified silicone/siloxane materials and/or resin system such as polydimethylsiloxane (PDMS). Either a fluid or powder form of releasing agent may be used as part of the coating composition.

To further enhance the colorant pass-through efficiency of the heat activated colorant, additives such as a foaming/blowing agent or agents may be added to the composition. Preferred foaming/blowing agent chemicals generate micropores upon completion of drying or curing of the opaque pass-through polymeric layer or membrane. This enhances the transport of the heat activated colorants to the thermoplastic or acrylic glass material during heat transfer.

Preferred foaming agents may include those which decompose upon heating to release gases that cause the ink layer to expand. Foaming agents of this type, known as chemical blowing agents or puffing agents, include organic expanding agents such as azo compounds, including azobisisobutyronitrile, azodicarbonamide, and diazoaminobenzene, nitroso compounds such as N,N′-dinitrosopentamethylenetetramine, N,N′-dinitroso-N,N′-dimethylterephthalamide, sulfonyl hydrazides such as benzenesulfonyl hydrazide, p-toluenesulfonyl hydrazide, p-toluenesulfonyl azide, hydrazolcarbonamide, acetone-p-sulfonyl hydrazone; and inorganic expanding agents, such as sodium bicarbonate, ammonium carbonate and ammonium bicarbonate azodicarbonamide.

Various other additives may be used. Physical property modifying agents, antioxidants, UV blocking agent/hindered amine light stabilizing agent, viscosity control agent, surface tension modifier, defoaming agent, wetting agent, dispersant, emulsifying agent, optical brightener, pH control agent, abrasion-resistance additives, etc. may be added. For radiation curable coating compositions, one or more light initiators or sensitizers may be used.

Various printing and coating methods, such as silk screen printing, spraying coating, transfer coating, pad printing, offset printing, brush coating, and/or digital printing method such as various inkjet printing method may be adopted for application of the opaque pass-through polymer layer to the acrylic. Various drying or curing methods, such as heat including infrared radiation (IR) and/or near IR during/curing, radiation curing, pressure, etc. may be used according to specific coating and/or reaction systems.

### Example

### Composition of a Preferred Opaque Pass-Through Polymer Layer

| | |
|---|---|
| Hexamethoxymethyl Malamine resin | 0-45% |
| Co-reactant | 0-50% |
| White Pigment | 2-15% |
| Catalyst | 0-3% |
| Releasing Agent | 0-10% |
| Other Coating Additives | 0-15% |
| Carrier | balance |

The dry coat weight of the opaque pass-through layer generally ranges from 5-60 g/m², and is preferably in the range of 10-45 g/m².

An optional high sublimation dye affinity layer 6, such as a polyester or polyurethane coating layer, may be present between the opaque pass-through polymeric layer and the acrylic glass base to further alter sublimation dye receptive properties. Application of this layer may be accomplished by known methods.

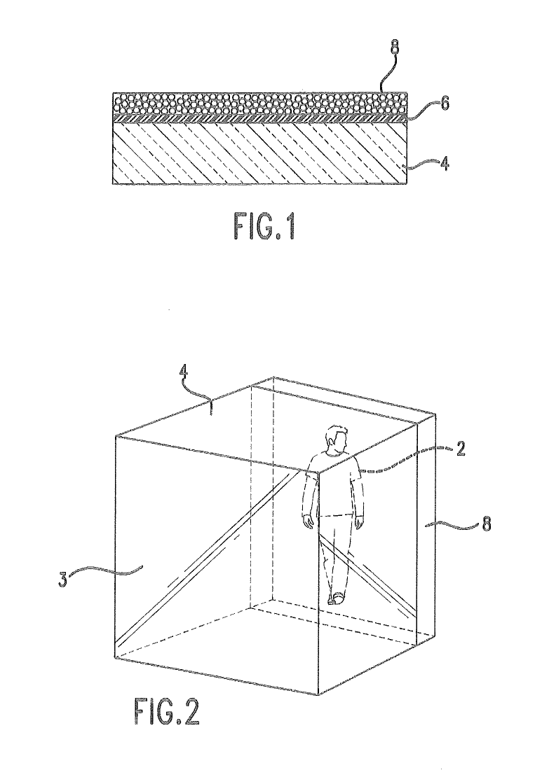

In one embodiment, an image is digitally printed on a substrate, such as paper or transfer paper that provides a transfer medium. Heat may be applied from the back of the sublimation transfer medium that is opposite the printed image, with intimate contact between the image layer and the opaque pass-through coating layer. Heat is preferably applied under pressure to transfer the image from the transfer medium to the acrylic glass. The heat activatable colorant is heat activated, and preferably is gasified to pass through the opaque layer to the thermoplastic substrate. The heat may simultaneously activate the colorants forming the image, and/or initiate reaction of components of the image layer, and/or bond and/or cross-linking ingredients of the image layer as well as the colorants. The image is now present between the opaque layer and the thermoplastic substrate, and is bonded permanently to the thermoplastic/acrylic glass and/or the optional colorant/sublimation dye affinity layer. Excellent durability and fastness properties can be achieved for the final design image as it is viewed through the clear/transparent acrylic glass. FIG. 2.

Appropriate levels of heat and pressure are applied during the transfer process to ensure proper surface contact between the medium and the coated acrylic substrate so as to not deform the acrylic glass material or depreciate the optical qualities of the acrylic glass material. A vacuum may be applied during the transfer process to further assist transfer efficiency.

To inhibit premature deformation and/or warping of the thermoplastic or acrylic glass due to overheating during heat transfer, the thermoplastic article is preferred to have a thickness that allows the heat capacity of the total article to be higher than the total heat created by the heat press, and depending on the heat capacity of the specific acrylic glass material. For instance, a thickness of 5 mm or more should be used with acrylic glass material of heat capacity of 1.5 J/g-C with platen heat press.

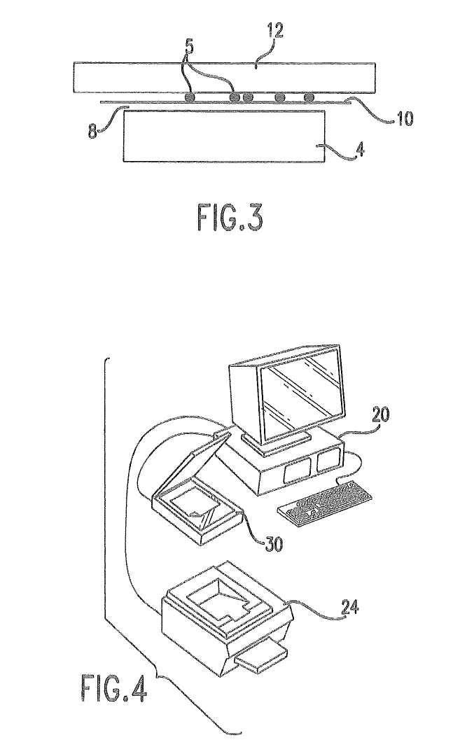

In yet another embodiment of the present invention, heat transfer is performed by applying heat to the transfer medium 10, which is in contact with the opaque coating, instead of uniformly heating the entire body of the article (such as is the case when a heating oven is used). FIG. 3. Heat may be applied by a platen 12 of a heat press. This method creates a temperature gradient that is higher at the top surface, and much lower toward the bottom of the article. The gasified sublimation colorant 5 is transported with high efficiency through the opaque pass-through polymeric layer, allowing the condensation and bonding of the sublimation image on the acrylic article, and inhibiting heat deformation and/ thermal warping of the article body. sublimation dyes and colorants. An image 2 may be printed on the medium 10 on a side of the medium that is opposite the base sheet. In a preferred embodiment, the image may be printed by a digital printer, such as a computer 20 driven ink jet printer 24. After the image is printed on the medium, the image is ready for transfer from the medium to the acrylic substrate.

The use of computer technology allows substantially instantaneous printing of images. For example, video cameras or scanners 30 may be used to capture a color image on a computer. Images created or stored on a computer may be printed on command, without regard to run size. The image may be printed onto the substrate from the computer by any suitable printing means capable of printing in multiple colors, including mechanical thermal printers, ink jet printers and electrophotographic or electrostatic printers, and transferred, as described above.

Computers and digital printers are inexpensive, and transfers of photographs and computer generated images may be made to substrates such as ceramics, textiles, and other articles. These transfers may be produced by end users at home, as well as commercial establishments. The image is transferred by the application of heat as described above.

The process may be used with transparent and translucent plastic substrates having similar characteristics to acrylics.

What is claimed is:

1. A method of transfer imaging, comprising the steps of:
forming an image comprising heat activatable colorant;
applying an opaque coating to a first surface of a thermoplastic material, wherein the thermoplastic material permits light to pass though the thermoplastic material from a surface of the thermoplastic material that is opposite the first surface;
placing the image against the opaque coating that is applied to the first surface of the thermoplastic material; and
applying heat to the image, wherein the heat activatable colorant is activated and the heat activatable colorant passes through the opaque coating and the image is formed between opaque coating and the first surface of the thermoplastic material.

2. A method of transfer imaging as described in claim 1, wherein the colorant gasifies upon application of heat and passes though the opaque coating.

3. A method of transfer imaging as described in claim 1, wherein the colorant sublimates upon application of heat and passes though the opaque coating.

4. A method of transfer imaging as described in claim 1, wherein the thermoplastic material is acrylic glass.

5. A method of transfer imaging as described in claim 1, wherein the thermoplastic material is transparent.

6. A method of transfer imaging as described in claim 1, wherein the thermoplastic material is translucent.

7. A method of transfer imaging as described in claim 1, wherein the thermoplastic material is tinted.

8. A method of transfer imaging as described in claim 1, wherein the colorant diffuses though the opaque coating upon application of heat to the image.

9. A method of transfer imaging as described in claim 1, wherein after heating of the colorant, the colorant returns to ambient temperature, and the colorant does not pass through the opaque coating.

10. A method of transfer imaging as described in claim 1, wherein the opaque coating is substantially white.

11. A method of transfer imaging as described in claim 1, wherein the opaque coating comprises titanium dioxide.

12. A method of transfer imaging as described in claim 1, wherein the colorant comprises sublimation dye, and wherein the sublimation dye gasifies upon the application of heat to the sublimation dye, and the gasified sublimation dye passes through the opaque coating.

13. A method of transfer imaging as described in claim 1, wherein the opaque layer is constructed to permit colorant that is heated as described in claim 1 to pass through the opaque coating.

14. A method of transfer imaging as described in claim 1, wherein the opaque layer comprises a polymer.

15. A method of transfer imaging as described in claim 1, wherein the heat activatable colorant bonds to a polymer between the opaque layer and the first surface of the thermoplastic material.

16. A method of transfer imaging as described in claim 1, wherein the opaque layer comprises a releasing material that is constructed to facilitate release of the heat activatable colorant from a substrate upon which the image is formed.

17. A method of transfer imaging as described in claim 1, wherein the image is formed on a substrate and the image is transferred from the substrate to pass through the opaque coating to the first surface of the thermoplastic material upon application of heat.

18. A method of transfer imaging as described in claim 1, wherein after the heat activatable colorant is activated and the heat activatable colorant passes through the opaque coating and the image is formed between opaque coating and the first surface of the thermoplastic material, the image is viewable through the surface of the thermoplastic material that is opposite the first surface.

19. An imaged thermoplastic material, comprising:
a thermoplastic material substrate, wherein the thermoplastic material substrate permits light to pass though the thermoplastic material substrate from a surface of the thermoplastic material substrate that is opposite a first surface of the thermoplastic material substrate;
an opaque coating that is present on the first surface of a thermoplastic material substrate, wherein the opaque coating is constructed and arranged to permit a heat activatable colorant to pass through the opaque coating when the heat activatable colorant is heat activated; and
an image comprising heat activatable colorant that is present between the opaque coating and the thermoplastic material substrate, wherein the image is viewable from the surface of the thermoplastic material substrate that is opposite the first surface of the thermoplastic material substrate.

20. An imaged thermoplastic material as described in claim 19, wherein the thermoplastic material substrate is acrylic glass.

21. An imaged thermoplastic material as described in claim 19, wherein the thermoplastic material substrate is transparent.

22. An imaged thermoplastic material as described in claim 19, wherein the thermoplastic material substrate is translucent.

23. An imaged thermoplastic material as described in claim 19, wherein the thermoplastic material substrate is tinted.

24. An imaged thermoplastic material as described in claim 19, wherein the opaque coating is substantially white.

25. An imaged thermoplastic material as described in claim 19, wherein the opaque coating comprises titanium dioxide.

26. An imaged thermoplastic material as described in claim 19, wherein the heat activatable colorant comprises sublimation dye, and wherein the opaque coating is constructed and arranged to permit gasified sublimation dye to pass through the opaque coating upon application of heat to the sublimation dye to gasify the sublimation dye.

27. An imaged thermoplastic material as described in claim 19, wherein the opaque layer comprises a polymer.

28. An imaged thermoplastic material as described in claim 19, wherein the heat activatable colorant bonds to a polymer that is present between the opaque layer and the first surface of the thermoplastic material substrate.
